(19) United States
(12) Patent Application Publication
(10) Pub. No.: US 2012/0155464 A1
(43) Pub. Date: Jun. 21, 2012

(54) COMMUNICATION NODE AND COMMUNICATION METHOD

(75) Inventors: Jung-Im KIM, Daejeon (KR); Heeyoung JUNG, Daejeon (KR)

(73) Assignee: Electronics and Telecommunications Research Institute, Daejeon (KR)

(21) Appl. No.: 13/331,163

(22) Filed: Dec. 20, 2011

(30) Foreign Application Priority Data
Dec. 21, 2010 (KR) 10-2010-0131952

(51) Int. Cl. H04L 12/56

(52) U.S. Cl. 370/390

(57) ABSTRACT

A communication node that requests and receives data contents is provided. The communication node broadcasts a first type of interest packet and receives one or more response packets in response thereto. The communication node selects one node among one or more nodes that have transmitted response packets, transmits a second type of interest packet to the selected node, and receives data contents from the selected node.

### CROSS-REFERENCE TO RELATED APPLICATION

This application claims priority to and the benefit of Korean Patent Application No. 10-2010-0131952 filed in the Korean Intellectual Property Office on Dec. 21, 2010, the entire contents of which are incorporated herein by reference.

### BACKGROUND OF THE INVENTION

(a) Field of the Invention

The present invention relates to a communication node and a communication method. In particular, the present invention relates to a communication node that requests and transmits data content, and a communication method.

(b) Description of the Related Art

Data services are rapidly increasing in the Internet. In order to support data services that are increasing at a fast pace, research into an effective transmission scheme in terms of faster transmission time and bandwidth is needed.

One of the implications of Internet data services on the increase is that the same data is repeatedly requested due to data requests from millions of people, like video and audio data in Google's YouTube.

Currently, the Internet transmission scheme uses an IP protocol. A transmission host includes an IP address of its own and an IP address of a reception host in a packet and transmits the packet, so an intermediate node, not the transmission host or the reception host, transmits the corresponding packet to the IP address of the reception host irrespective of the data contents. Thus, even the same data is processed differently and the same data is repeatedly transmitted, which is inefficient. In order to overcome such non-efficiency, various research studies, such as contents centric networking (CCN) and the like are underway.

According to various research studies such as on CCN and the like, when a service is performed through the Internet, the name of the data contents desired to be transmitted, rather than an IP address, is used. Also, instead of a transmission host and a reception host, the concept of a contents publisher who creates contents and a contents consumer who wants to receive contents is used. Further, since contents are transferred by using the name of the contents, Internet intermediate nodes, rather than the publisher or consumer, can recognize what the data is and cache it.

According to CCN, when a contents consumer who wants to receive contents broadcasts a contents request packet including the name of the contents, a node having the contents sends the contents in a reverse direction of the path of the contents request packet, and accordingly, the contents consumer can receive the contents. In the CCN, the contents request packet is called an interest packet. When an intermediate node between a publisher and the contents consumer receives the interest packet and retains the contents, the intermediate node may be able to send the contents in response.

According to the CCN, when there are many consumers, the consumers may be able to receive data through an intermediate node, whereby a repeated transmission can be avoided and contents can be quickly received.

However, when many nodes have contents, the intermediate node that has broadcast interest packets through various interfaces receives multiple contents transmitted from several nodes having contents, so the intermediate node must check whether or not contents is repeated and delete repeated contents. Thus, the operation of the node is complicated. Also, since several nodes repeatedly transmit the same data for an interest packet, bandwidth efficiency is reduced.

FIG. 1A and FIG. 1B show the related art contents requesting method.

Specifically, FIG. 1 and FIG. 1B illustrate an example in which client 1 and client 2 transmit interest packets requesting Google data contents and receive contents in response, showing that a repeated transmission may be made.

Diagram (a) of FIG. 1A shows relationships among clients, intermediate nodes, and a Google node. As shown in diagram (a) of FIG. 1A, clients 1, 2, and 3 and the Google node are connected by intermediate nodes A, B, C, D, E, F, G, H, I, J, and K.

Diagram (b) of FIG. 1A shows a process of requesting contents by client 1. As shown in diagram (b) of FIG. 1A, an interest packet may be transferred to the Google node through various paths. Namely, in diagram (b) of FIG. 1A, an interest packet can be transferred through a first path (1->H->D->B->A->Google), a second path (1->H->D->B->C->A->Google), and a third path (1->H->D->E->F->G->C->A->Google).

Diagram (c) of FIG. 1A shows a process of receiving contents by client 1. As shown in diagram (c) of FIG. 1A, contents are transferred from the Google node to client 1 through reverse paths of the three paths through which the interest packet was transferred.

Diagram (d) of FIG. 1B shows intermediate nodes that cache contents. The intermediate nodes A, B, C, D, E, F, G, and H may be able to cache contents by the contents requesting process and contents transferring process in diagram (b) of FIG. 1A and diagram (c) of FIG. 1A.

Diagram (e) of FIG. 1B shows a process of requesting contents by client 2. As shown in diagram (e) of FIG. 1B, an interest packet of client 2 is transmitted to intermediate node D or intermediate node E through intermediate node I. Here, since the intermediate nodes D and E cache data contents, they do not transfer the interest packet to a different node any longer.

Diagram (f) of FIG. 1B shows a process of receiving contents by client 2. As shown in diagram (f) of FIG. 1B, the intermediate node I repeatedly receives contents from the intermediate nodes D and E and provides the received contents to the client 2.

According to the current Internet system, when client 1 requests data from the Google node, the intermediate nodes merely transfer data without recognizing what the transferred data is or storing the data. However, according to the system such as the CNN, or the like, the intermediate nodes may be able to cache data because they perform transmission by using a data name. Also, as shown in FIG. 1A and FIG. 1B, when an intermediate node between a client and Google node caches contents, the client can receive contents from the intermediate node rather than the Google node, reducing the contents transmission time and the use of bandwidth. However, after the client 1 transmits an interest packet, the intermediate node B may receive the same data from the intermediate nodes A and C, and the intermediate node D may receive the same data from the intermediate nodes B and E. Also, after the client 2 transmits an interest packet, the node I may receive the same data from the nodes D and E. Accordingly, the design of the intermediate nodes is complicated, and the usage of bandwidth may be increased.

Currently, an Internet data service mainly uses TCP (transmission control protocol) and UDP (user datagram protocol). The TCP supports retransmission, while the UDP does not. According to the TCP and UDP, an end-end principle is applied in a transport layer, only an end node reads data of the transport layer. The TCP and UDP packet include a header and data, the transmission host includes a checksum in the header and transmits a packet, and a reception host checks the checksum to recognize whether there is an error. In the current Internet system, Internet intermediate nodes, excluding the transmission host and the reception host, cannot detect a packet error.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a communication node and a communication device having advantages of preventing unnecessary repeated transmission of data contents and spreading of an error of data contents.

An exemplary embodiment of the present invention provides a communication method of a communication node, including: broadcasting a first type of interest packet; receiving one or more response packets with respect to the first type of interest packet; transmitting a second type of interest packet to a selected node corresponding to one response packet among the one or more response packets; and receiving data contents from the selected node.

The transmitting of the second interest packet may include: determining a node that first transmitted a response packet among the one or more response packets, as the selected node; and transmitting the second interest packet to the selected node.

The receiving of the data contents may include: receiving one of a plurality of segments of the data contents from the selected node; and additionally transmitting the second type of interest packet to receive the remaining segments among the plurality of segments.

The first type of interest packet, the response packet, and the second type of response packet may include a name field of data contents related to a packet, a type field of a packet, and a random variable field, respectively.

The first type of interest packet, the response packet, and the second type of response packet may include a name field of data contents related to a packet and a random variable field, respectively.

The random variable field of the response packet may correspond to a complement of the random variable field of the first type of interest packet.

The random variable field of the second type of interest packet may correspond to a random variable field of an interest packet of the response packet.

Another embodiment of the present invention provides a communication node including: a packet broadcasting unit broadcasting a first type of interest packet; a packet reception unit receiving one or more response packets with respect to the first type of interest packet; a node selection unit determining one node among one or more nodes that have transmitted one or more response packets, as a selected node; a packet transmission unit transmitting a second type of interest packet to the selected node; and a contents reception unit receiving data contents from the selected node.

The node selection unit may determine a node that has first transmitted a response packet among the one or more response packets as the selected node.

The data contents may include a plurality of segments.

The communication node may further include a segment combining unit combining segments provided from the contents reception unit, and when there is a remaining segment, the segment combining unit enables the packet transmission unit to additionally transmit the second type of interest packet to thus request the remaining segment.

Yet another embodiment of the present invention provides a communication method of a communication node, including: receiving a first type of interest packet; when there are data contents corresponding to the first type of interest packet, transmitting a response packet to a contents consumption node that has transmitted the first type of interest packet; receiving a second type of interest packet from the contents consumption node; and transmitting data contents corresponding to the second type of interest packet to the contents consumption node.

The communication method may further include determining a delay time according to data throughput or an amount of available resource.

The transmitting of the response packet may include transmitting the response packet after lapse of the delay time.

The data contents may include a plurality of segments.

The transmitting of the data contents may include transmitting each of the plurality of segments in response to the second type of interest packet after the response packet is transmitted.

The communication method may further include, when there are no data contents corresponding to the first type of interest packet, broadcasting the first type of interest packet.

The communication method may further include receiving distributed data contents and storing the data contents.

The storing of the data contents may include: determining an error by checking a checksum of the data contents; checking a signature of the data contents when there is no error; and storing the data contents when the signature is checked.

Still another embodiment of the present invention provides a communication node including: a contents storage unit storing data contents; a packet reception unit receiving a first type of interest packet and a second type of interest packet; a contents checking unit determining whether or not interest contents corresponding to the first type of interest packet exist in the contents storage unit; a packet transmission unit transmitting a response packet to a contents consumption node that has transmitted the first type of interest packet when the interest contents exists in the contents storage unit; and a contents transmission unit transmitting interest contents corresponding to the second type of interest packet to the contents consumption node.

The communication node may further include: a delay time determining unit determining a delay time according to data throughput and an amount of available resource, wherein the packet transmission unit may transmit the response packet after the lapse of the delay time.

The data contents may include a plurality of segments.

The contents transmission unit may transmit each of the plurality of segments in response to the second type of interest packet after the response packet is transmitted.

### BRIEF DESCRIPTION OF THE DRAWINGS

FIG. 1A and FIG. 1B are a view showing a related art contents requesting method.

FIG. 2A and FIG. 2B are a view showing a data contents transmitting method according to an embodiment of the present invention.

FIG. 3 is a view showing the structure of a packet according to an embodiment of the present invention.

FIG. 4 is a view showing the structure of a packet according to another embodiment of the present invention.

FIG. 5 is a view showing the structure of a protocol according to an embodiment of the present invention.

FIG. 6 is a flowchart illustrating an operation of a contents consumption node according to an embodiment of the present invention.

FIG. 7 is a schematic block diagram of the contents consumption node according to an embodiment of the present invention.

FIG. 8 is a flow chart illustrating an operation of an intermediate node according to an embodiment of the present invention.

FIG. 9 is a schematic block diagram showing the configuration of an intermediate node according to an embodiment of the present invention.

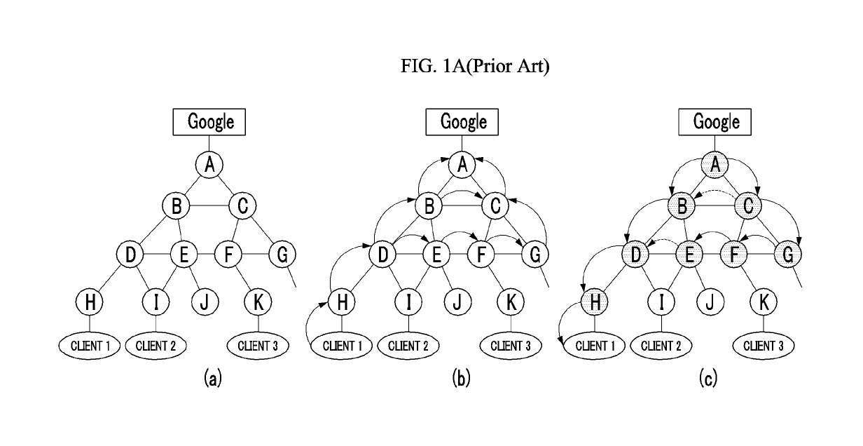

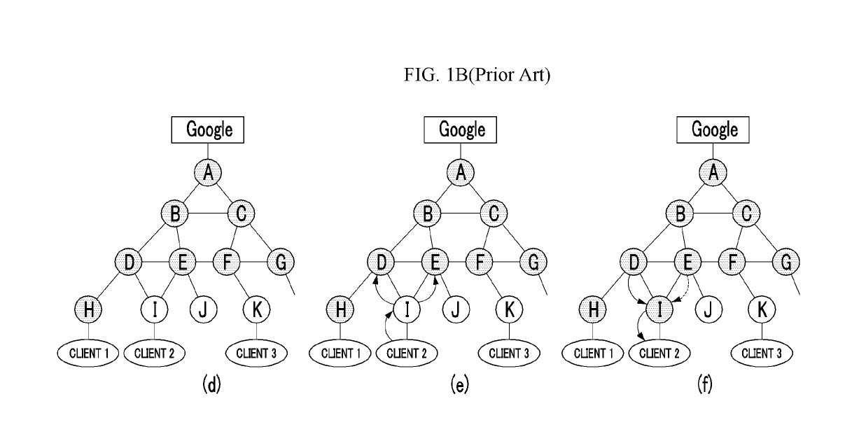

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. Throughout the specification, unless explicitly described to the contrary, the word “comprise” and variations such as “comprises” or “comprising” will be understood to imply the inclusion of stated elements but not the exclusion of any other elements.

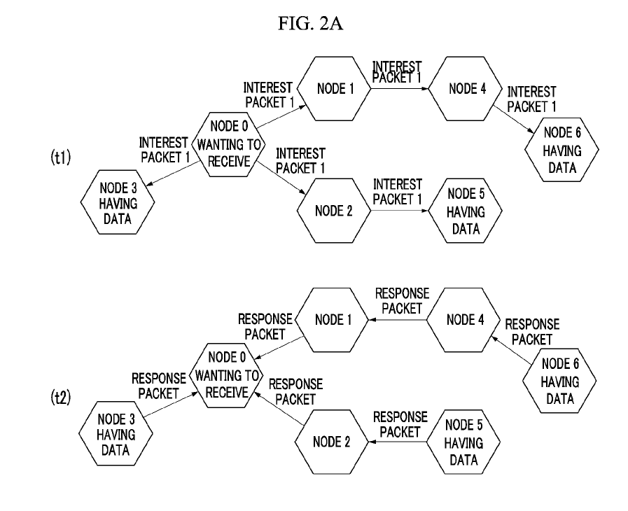

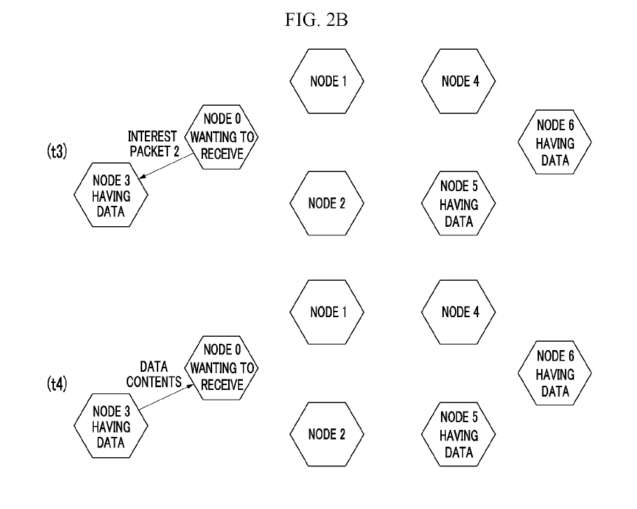

A method for controlling repeated transmission according to an embodiment of the present invention will be described with reference to FIGS. 2A, 2B, 3, and 4.

According to an embodiment of the present invention, an interest packet 1, a response packet with respect to the interest packet 1, and an interest packet 2 are used to request contents.

First, a node that wants to receive data contents broadcasts the interest packet 1 to a plurality of nodes. Upon receiving the interest packet 1, the nodes searches whether there is data corresponding to a data name written in the interest packet 1 in a data buffer. When data contents are present in the data buffer, the nodes that have received the interest packet 1 transmit a response packet in response, to the node that transmitted the interest packet 1.

When the node that wants to receive data contents receives one or more response packets, the node selects only one node and transmits the interest packet 2 thereto. For example, the node that wants to receive data contents may transmit the interest packet 2 to a node whose response packet was first received.

When the node that has transmitted the response packet upon receiving the interest packet 1 receives the interest packet 2, the node transmits data contents through a reverse path of a path along which the interest packets 1 and 2 were received. Accordingly, the node that wants to receive data contents can receive data from only one node.

FIG. 2A and FIG. 2B are a view showing a data contents transmitting method according to an embodiment of the present invention.

In FIG. 2A, (t1) shows a transmission process of the interest packet 1, (t2) shows a transmission process of the response packet. Also, in FIG. 2B, (t3) shows a transmission process of the interest packet 2, and (t4) shows a transmission process of data contents.

In FIG. 2A and FIG. 2B, a node 0 is a node that wants to receive contents, nodes 1, 2, and 4 are nodes without contents, and nodes 3, 5, and 6 are nodes with contents.

As shown in (t1) of FIG. 2A, the node 0 broadcasts the interest packet 1. Accordingly, the interest packet 1 is transferred to the nodes 3, 5, and 6 with contents through a first path (0->3), a second path (0->1->4->6), and a third path (0->2->5).

As shown in (t2) of FIG. 2A, the nodes 3, 5, and 6 with contents transfer response packets with respect to the interest packet 1 to the node 0 through a reverse path of the transmission path of the interest packet 1.

The node 0 that has transmitted the interest packet 1 and received response packets from a plurality of nodes selects one node among those that have transmitted the response packets, and transmits the interest packet 2 to the selected node. The node 0 may transmit the interest packet 2 to the node that transmitted a response packet that has arrived first. When the node that has received the interest packet 1 is busy in processing a great amount of contents irrespective of the interest packet 1, the node may slowly make a response and may not transmit contents corresponding to the interest packet 1. Namely, contents requests are prevented from pressing together to one node by adjusting a transmission time of response packets. When the interest packet 2 does not arrive at the node that received the interest packet 1 and has transmitted a corresponding response packet within a predetermined time the node that has transmitted the response packet may delete the interest packet 1 without transmitting data contents.

The nodes store input and output interfaces of the interest packet 1, the interest packet 2, and the response packet. This is because one node is connected to several nodes, so each node must transmit a response packet to a node to which the interest packet 1 has been input, and transmit contents to a node to which the interest packet 2 has been input.

Meanwhile, the interest packet 1, the interest packet 2, and the response packet are required to be discriminated. If the interest packet 1, the interest packet 2, and the response packet are used without being discriminated, since the interest packet 1 is broadcast, it is complicated for one node to trace a proceeding path of the interest packet 1 and it is difficult for one node to know about it. Thus, if the interest packet 1, the interest packet 2, and the response packet are not discriminated, whether or not a single packet forms a loop so as to be repeatedly input or whether or not different packets are input would not be discriminated, making it impossible to prevent formation of a loop.

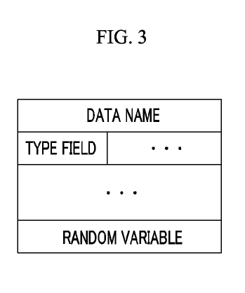

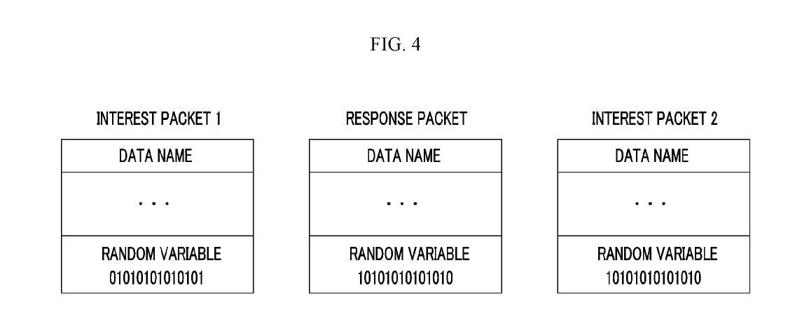

The structure of a packet according to an embodiment of the present invention will be described with reference to FIGS. 3 and 4.

FIG. 3 is a view showing the structure of a packet according to an embodiment of the present invention.

As shown in FIG. 3, a packet according to an embodiment of the present invention includes a data name field, a type field, and a random variable field.

The data name field indicates a name of contents related to a packet, the type field indicates a type of the packet, and the random variable field includes a random variable generated by a node that wants to receive contents.

The packet according to FIG. 3 may be classified into an interest packet 1, an interest packet 2, and a response packet by the type field. For example, when a packet includes a 2-bit type field, type fields corresponding to 00, 01, and 10 correspond to the interest packet 1, the response packet, and the interest packet 2, respectively. The use of the packet according to FIG. 3 may easily discriminate a type of the packet by the type field. However, signaling overhead is increased for transmission of the type field.

FIG. 4 is a view showing the structure of a packet according to another embodiment of the present invention.

As shown in FIG. 4, packets according to this embodiment of the present invention include a data name field and a random variable field, respectively.

In the case according to FIG. 4, the random variable field of a response packet may include a complement of the random variable of the interest packet 1, and the random variable field of the interest packet 2 may include a random variable of the response packet.

In this case, when the nodes receive the interest packet 1, the interest packet 2, or the response packet, they first read a data name to check the presence of the interest packet 1, the interest packet 2, or the response packet. Further, the nodes may identify the type of the received packets through the random variable field. To this end, every node manages a list of the interest packet 1, the interest packet 2, and the response packet that are input and output.

The use of the packets according to FIG. 4 does not increase signaling overhead in comparison to the case of using the packet according to FIG. 3. Meanwhile, each node must calculate the complement value of the random variable with respect to the response packet, so complexity is slightly increased.

Data contents may include several segments. Since a contents consumer has selected a node to avoid a repeated contents transmission, the interest packet 1 and the response packet may cause an unnecessary loss of bandwidth and data delay. Thus, when contents include several segments, a first segment among the segments may be transmitted through signaling of the interest packet 1, the response packet, and the interest packet 2, and the second segment to the last segment may be transmitted through signaling of only the interest packet 2.

In a first embodiment for transmission of data contents including several segments, the node that has transmitted the first segment may store a name of data contents corresponding to the first segment, an input interface, and an output interface without deletion until all the segments are transferred. In this manner, the node that has transmitted the first segment may transmit the remaining segments only when the interest packet 2 is received, without receiving the interest packet 1 and transmitting the response packet, starting from the transmission of the second segment.

In a second embodiment for transmission of data contents including several segments, the node that has transmitted the first segment may maintain a name of data contents corresponding to the first segment, an input interface, and an output interface for a predetermined time, and when the predetermined time has lapsed, the node may delete them. Here, the predetermined time is a previously determined value that all of a contents publisher, an intermediate node, and a contents consumer are aware of with respect to a corresponding service. When the contents transmission is not completed during the predetermined time, the other remaining segments are transmitted again through signaling of the interest packet 1, the response packet, and the interest packet 2.

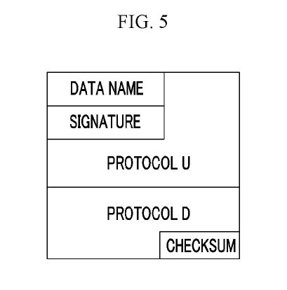

Hereinafter, a method for detecting a packet error according to an embodiment of the present invention will be described with reference to FIG. 5.

In the current Internet system, only a reception node performs packet error detection. According to the TCP, when an error is detected, the reception node requests retransmission. According to the UDP, when an error is detected, the reception node discards the erroneous packet.

According to an embodiment of the present invention, when intermediate nodes cache data contents and distribute data contents, error detection and signature checking are performed on the data contents. When an error is detected, or when a signature is not checked so the data contents is not interpreted as valid data, the intermediate nodes do not transmit the data contents having a detected error or the data contents whose signature is not checked to a consumer who has transmitted an interest packet or a new consumer.

According to CCN, the contents include a signature, and the contents consumer determines validity of the data contents upon checking the signature. The valid contents refer to contents that have been created by a publisher and have not been changed, and it corresponds to the name of the contents. Contents may include several segments. Here, a signature may be attached to each segment, or several segments may share a single signature.

The intermediate node, while caching the contents, inspects a checksum of the cached data to check whether or not an error is generated.

FIG. 5 is a view showing the structure of a protocol according to an embodiment of the present invention. In particular, FIG. 5 shows an example in which a protocol for a checksum and a protocol for a signature are different.

As shown in FIG. 5, when the protocol D that attaches a checksum is placed under the protocol U that attaches a contents name and a signature, the protocol D that attaches the check sum reports whether or not an error has occurred to the upper protocol U that attaches the contents name and signature.

The protocol U that attaches a contents name and a signature determines whether to perform distribution according to the report of error generation and checks a signature. Accordingly, the intermediate node may not distribute the error-detected data to the other nodes, and the contents consumer may not perform reception calculation on the error-generated data. Also, the intermediate node can be prevented from distributing data that is invalid because its signature is not checked to the internet. Also, when the system permits retransmission, the intermediate node, which has detected the error and transmits the interest packet again, requests retransmission of contents, and the contents consumer may more quickly receive contents.

Meanwhile, when an error is detected from an intermediate segment among a plurality of segments, although there is no error in segments received thereafter, the data contents are determined to be data that is not valid in terms of a signature inspection. Accordingly, in the system that is available for contents retransmission, a node may quickly retransmit an interest packet to request retransmission of data contents. In a system that is unavailable for retransmission of data contents, a node may not transmit an interest packet any further, so it may not receive data to be determined to be invalid any further.

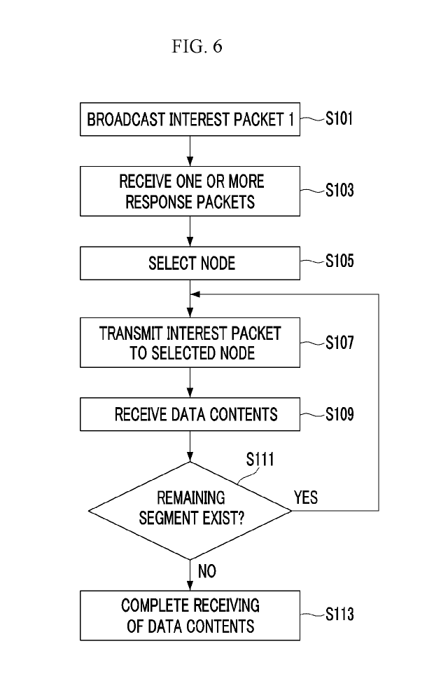

Hereinafter, the configuration and operation of a contents consumption node and an intermediate note according to an embodiment of the present invention will be described with reference to FIGS. 6 to 9.

FIG. 6 is a flow chart illustrating an operation of a contents consumption node according to an embodiment of the present invention.

First, a contents consumption node 100 broadcasts the interest packet 1 (S101).

Next, the contents consumption node 100 receives one or more response packets from one or more nodes (S103).

The contents consumption node 100 selects at least one node among nodes that have transmitted response packets (S105). Here, the contents consumption node 100 may select a node that transmitted a response packet that was first received.

Then, the contents consumption node 100 transmits the interest packet 2 to the selected node (S107) and receives data contents from the selected node (S109).

When the data contents includes a plurality of segments, the contents consumption node 100 determines whether or not there is a remaining segment that has not yet been received (S111).

When there is a remaining segment, the contents consumption node 100 transits the interest packet 2 to the selected node to request the remaining segment.

When there is no remaining segment, receiving of the data contents is completed (S113).

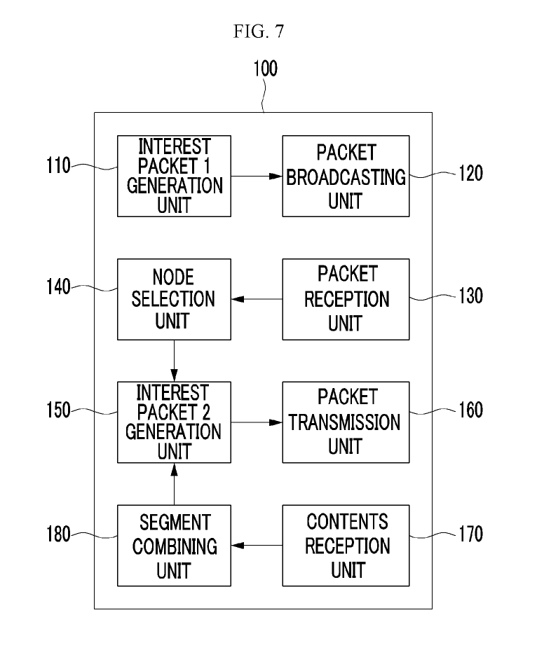

FIG. 7 is a schematic block diagram of the contents consumption node according to an embodiment of the present invention. In particular, the contents consumption node 100 illustrated in FIG. 7 may perform the operation of the contents consumption node 100 according to FIG. 6.

As shown in FIG. 7, the contents consumption node 100 according to an embodiment of the present invention includes an interest packet 1 generation unit 110, a packet broadcasting unit 120, a packet reception unit 130, a node selection unit 140, an interest packet 2 generation unit 150, a packet transmission unit 160, a contents reception unit 170, and a segment combining unit 180.

The interest packet 1 generation unit 110 generates the interest packet 1 and transfers the generated interest packet 1 to the packet broadcasting unit 120.

The packet broadcasting unit 120 broadcasts the interest packet 1 to a node connected to the contents consumption node 100.

The packet reception unit 130 receives a response packet with respect to the interest packet 1 and transfers the received response packet to the node selection unit 140.

The node selection unit 140 selects one node among one or more nodes that have transmitted response packets, and provides information regarding the selected node to the interest packet 2 generation unit 150.

The interest packet 2 generation unit 150 may generate an interest packet 2 to be transmitted to the selected node, and transfers the generated interest packet 2 to the packet transmission unit 160.

The packet transmission unit 160 transmits the interest packet 2 to the selected node.

The contents reception unit 170 receives contents or segments and transfers the same to the segment combining unit 180.

The segment combining unit 180 combines the segments provided from the contents reception unit 170, and when there is a remaining segment, the segment combining unit 180 may inform the interest packet 2 generation unit 150 accordingly so that the interest packet 2 generation unit 150 can generate the interest packet 2 for requesting the remaining segment.

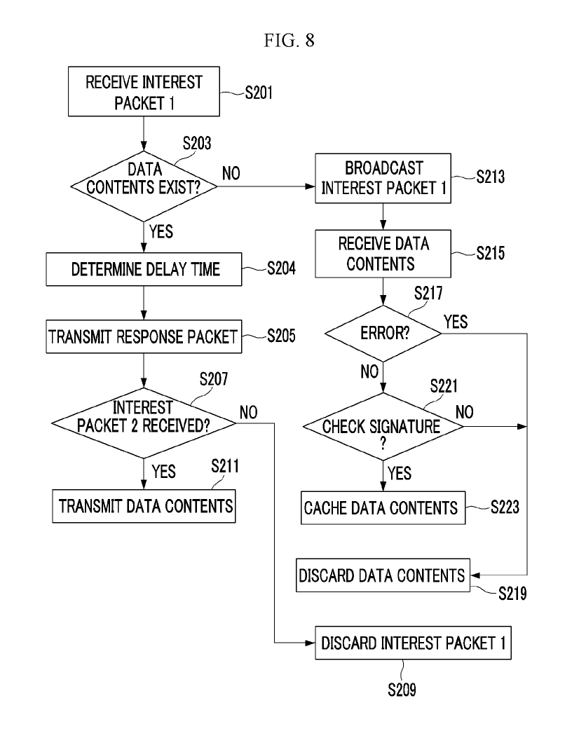

FIG. 8 is a flowchart illustrating an operation of an intermediate node according to an embodiment of the present invention.

First, an intermediate node 200 receives the interest packet 1 (S201). Here, the intermediate node 200 may store information regarding an input interface of the interest packet 1, and the interest packet 1.

The intermediate node 200 determines whether or not it caches data contents corresponding to the interest packet 1 (S203).

When the intermediate node 200 caches the data contents, the intermediate node 200 determines a delay time for transmitting a response packet according to data throughput or an amount of available resource (S204). When the data throughput is small or the amount of available resource is large, the intermediate node 200 may determine the delay time as a relatively small value or 0. Meanwhile, when the data throughput is large or the amount of available resource is small, the intermediate node 200 may determine the delay time as a relatively large value.

After the lapse of the determined delay time, the intermediate node 200 transmits a response packet to the node that transmitted the interest packet 1 through a reverse path of the transfer path of the interest packet 1 (S205). Here, the intermediate node 200 may store information regarding an output interface of the response packet, and the response packet.

The intermediate node 200 waits to receive the interest packet 2 (S207). When the intermediate node 200 fails to receive the interest packet 2 when a certain time has lapsed, the intermediate node 200 may discard the information regarding the input interface of the interest packet 1, the information regarding the output interface of the response packet, and the response packet (S209).

When the intermediate node 200 receives the interest packet 2 with respect to the response packet, the intermediate node 200 transmits data contents corresponding to the interest packet 2 to the node that transmitted the interest packet 2 (S211). Here, the intermediate node 200 may store information regarding an input interface of the interest packet 2, and the interest packet 2. Also, when the data contents include a plurality of segments, the intermediate node 200 may transmit one segment corresponding to the interest packet 2 among the plurality of segments. Thereafter, with respect to the node to which the intermediate node 200 has transmitted the response packet, the intermediate node 200 transmits the other remaining segments in response to reception of the interest packet 2.

Meanwhile, when the intermediate node 200 does not cache data contents, the intermediate node 200 broadcasts the interest packet 1 to the nodes connected thereto (S213).

After the transmission of the interest packet 1, when the intermediate node 200 receives data contents (S215), the intermediate node 200 checks a checksum of the data contents (S217).

When there is an error in the data contents according to the results of checking the checksum, the intermediate node 200 discards the data contents, rather than caching it (S219).

When there is no error in the data contents according to the results of checking the checksum, the intermediate node 200 checks a signature of the data contents (S221).

When a signature is not checked, the intermediate node 200 discards the data contents, rather than caching it (S219).

When a signature is checked, the intermediate node 200 caches the data contents (S223).

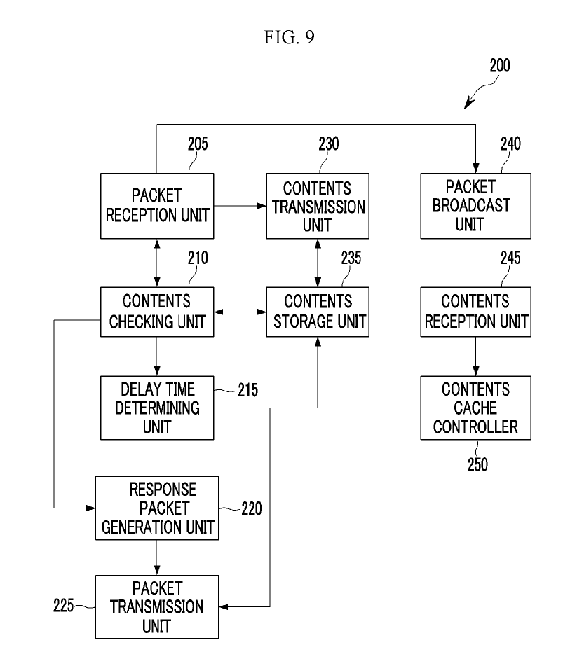

FIG. 9 is a schematic block diagram showing the configuration of an intermediate node according to an embodiment of the present invention.

As shown in FIG. 9, the intermediate node 200 according to an embodiment of the present invention includes a packet reception unit 205, a contents checking unit 210, a delay time determining unit 215, a response packet generation unit 220, a response packet transmission unit 225, a contents transmission unit 230, a contents storage unit 235, a packet broadcasting unit 240, a contents reception unit 245, and a contents cache controller 250.

The packet reception unit 205 receives the interest packet 1 and the interest packet 2, and manages storing and discarding of information regarding an input interface of the interest packet 1, information regarding an input interface of the interest packet 2, the interest packet 1, and the interest packet 2. The packet reception unit 205 transfers the interest packet 1 to the contents checking unit 210 and the second packet 2 to the contents transmission unit 230.

When the contents checking unit 210 receives the interest packet 1, the contents checking unit 210 recognizes whether or not data contents corresponding to the interest packet 1 exist in the contents storage unit 235. When data contents exist, the contents checking unit 210 informs the delay time determining unit 215 and the response packet generation unit 220 about the presence of the data contents. When data contents do not exist, the contents checking unit 210 informs the packet reception unit 205 that data contents do not exist. Here, the packet reception unit 205 transfers the interest packet 1 to the contents reception unit 245, and the packet broadcasting unit 240 broadcasts the interest packet 1.

When data contents exists in the contents storage unit 235, the delay time determining unit 215 determines a delay time for transmitting a response packet according to data throughput or an amount of available resource, and provides information regarding the delay time to the response packet transmission unit 225.

When data contents exist in the contents storage unit 235, the response packet generation unit 220 generates a response packet with respect to the interest packet 1 and provides the generated response packet to the response packet transmission unit 225.

After the lapse of the delay time determined by the delay time determining unit 215, the response packet transmission unit 225 transmits the response packet to the contents consumption node 100 that transmitted the interest packet 1, through the input interface of the interest packet 1.

The contents transmission unit 230 receives the interest packet 2 from the packet reception unit 205, and ascertains that the node that has transmitted the interest packet 2 and the reception node of the response packet are identical. When the two nodes are identical, the contents transmission unit 230 reads data contents or segments corresponding to the interest packet 2 from the contents storage unit 235 and transmits the same to the contents consumption node 100 that transmitted the interest packet 2.

The contents reception unit 245 may receive distributed data contents. Here, the contents reception unit 245 transfers the received data contents to the contents cache controller 250.

The contents cache controller 250 checks a checksum of the data contents to recognize the presence of an error, checks a signature of the data contents, and stores valid data contents in the contents storage unit 235.

As described above, the contents consumption node and the intermediate note have been separately described, but there is no need to classify nodes into a contents consumption node, an intermediate node, and a contents publisher node. That is, the intermediate node or the contents publisher node may have the function of the contents consumption node. Also, the contents consumption node or the contents publisher node may have the function of the intermediate node.

According to an embodiment of the present invention in a system, like a CCN system in which an interest packet is broadcast and data contents is transmitted in response thereto, whether or not a specific node is to transmit contents in response to an interest packet may be determined. Also, since a contents consumer is prevented from receiving multiple contents unnecessarily, data throughput can be reduced and bandwidth usage efficiency can be enhanced.

In addition, since data having an error is prevented from being distributed to several nodes, an error does not spread in the system. In a system allowed for retransmission, retransmission can be quickly made, and distribution of data not authenticated, which is thus invalid, is reduced.

The embodiments of the present invention are not necessarily implemented only through the foregoing devices and methods, but may also be implemented through a program for realizing functions corresponding to the configurations of the embodiments of the present invention, a recording medium including the program, or the like, and such an implementation may be easily made by a skilled person in the art to which the present invention pertains from the foregoing description of the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication method of a communication node, the method comprising:
broadcasting a first type of interest packet;
receiving one or more response packets with respect to the first type of interest packet;
transmitting a second type of interest packet to a selected node corresponding to one response packet among the one or more response packets; and
receiving data contents from the selected node.

2. The method of claim 1, wherein the transmitting of the second interest packet comprises:
determining a node that first transmitted a response packet among the one or more response packets, as the selected node; and
transmitting the second interest packet to the selected node.

3. The method of claim 2, wherein the receiving of the data contents comprises:
receiving one of a plurality of segments of the data contents from the selected node; and
additionally transmitting the second type of interest packet to receive the remaining segments among the plurality of segments.

4. The method of claim 3, wherein the first type of interest packet, the response packet, and the second type of response packet comprise a name field of data contents related to a packet, a type field of a packet, and a random variable field, respectively.

5. The method of claim 3, wherein the first type of interest packet, the response packet, and the second type of response packet comprise a name field of data contents related to a packet and a random variable field, respectively.

6. The method of claim 5, wherein the random variable field of the response packet corresponds to a complement of the random variable field of the first type of interest packet.

7. The method of claim 6, wherein the random variable field of the second type of interest packet corresponds to a random variable field of an interest packet of the response packet.

8. A communication node comprising:
a packet broadcasting unit broadcasting a first type of interest packet;
a packet reception unit receiving one or more response packets with respect to the first type of interest packet;
a node selection unit determining one node among one or more nodes that have transmitted one or more response packets, as a selected node;
a packet transmission unit transmitting a second type of interest packet to the selected node; and
a contents reception unit receiving data contents from the selected node.

9. The communication node of claim 8, wherein the node selection unit determines a node that has first transmitted a response packet among the one or more response packets as the selected node.

10. The communication node of claim 9, wherein the data contents comprises a plurality of segments,
and the communication node further comprises a segment combining unit combining segments provided from the contents reception unit, and when there is a remaining segment, the segment combining unit enables the packet transmission unit to additionally transmit the second type of interest packet to thus request the remaining segment.

11. A communication method of a communication node, the method comprising:
receiving a first type of interest packet;
when there are data contents corresponding to the first type of interest packet, transmitting a response packet to a contents consumption node that has transmitted the first type of interest packet;
receiving a second type of interest packet from the contents consumption node; and
transmitting data contents corresponding to the second type of interest packet to the contents consumption node.

12. The method of claim 11, further comprising determining a delay time according to data throughput or an amount of available resource,
wherein the transmitting of the response packet comprises transmitting the response packet after lapse of the delay time.

13. The method of claim 12, wherein the data contents comprises a plurality of segments,
wherein the transmitting of the data contents comprises transmitting each of the plurality of segments in response to the second type of interest packet after the response packet is transmitted.

14. The method of claim 11, further comprising, when there are no data contents corresponding to the first type of interest packet, broadcasting the first type of interest packet.

15. The method of claim 14, further comprising:
receiving distributed data contents; and
storing the data contents.

16. The method of claim 15, wherein the storing of the data contents comprises:
determining an error by checking a checksum of the data contents;
checking a signature of the data contents when there is no error; and
storing the data contents when the signature is checked.

17. A communication node comprising:
a contents storage unit storing data contents;
a packet reception unit receiving a first type of interest packet and a second type of interest packet;
a contents checking unit determining whether or not interest contents corresponding to the first type of interest packet exists in the contents storage unit;
a packet transmission unit transmitting a response packet to a contents consumption node that has transmitted the first type of interest packet when the interest contents exist in the contents storage unit; and
a contents transmission unit transmitting interest contents corresponding to the second type of interest packet to the contents consumption node.

18. The communication node of claim 17, further comprising a delay time determining unit determining a delay time according to data throughput and an amount of available resource, wherein the packet transmission unit transmits the response packet after the lapse of the delay time.

19. The communication node of claim 17, wherein the data contents comprises a plurality of segments,
wherein the contents transmission unit transmits each of the plurality of segments in response to the second type of interest packet after the response packet is transmitted.
